(19) United States
(12) Patent Application Publication
(10) Pub. No.: US 2005/0010721 A1
(43) Pub. Date: Jan. 13, 2005

(54) Method of transferring data for efficiently using drive apparatus

(76) Inventor: Junichi Tanjima, Kanagawa (JP)

Correspondence Address: Mark J. Thronson;DICKSTEIN SHAPIRO MORIN & OSHINSKY LLP, 2101 L. Street NW, Washington, DC, 20037-1526, US

(21) Appl. No.: 10/912,168

(22) Filed: Aug. 6, 2004

Related U.S. Application Data
(63) Continuation of application No. PCT/JP04/03145, filed on Mar. 10, 2004.

(30) Foreign Application Priority Data
Mar. 20, 2003 (JP) 2003-077976

(51) Int. Cl. G06F 12/00; G11B 5/09

(52) U.S. Cl. 711/113; 711/118

(57) ABSTRACT

An apparatus for transferring data to a drive apparatus is disclosed. The data are temporarily held in a memory of the drive apparatus for subsequent recording in a recording medium. The apparatus includes a first unit which performs for multiple repetitions a first process of transferring the data to the drive apparatus and a second process of converting data for a subsequent transfer to data processable at the drive apparatus. In addition, a second unit indicates timing in accordance with the amount of data and a rate of transferring the data. A third unit causes the drive apparatus to record, during a period in which the second process is executed and the first process is not executed, in the recording medium at the indicated timing, the data being temporarily held in the memory of the drive apparatus.

### CROSS-REFERENCE TO RELATED APPLICATION

This application is a U.S. continuation application filed under 35 USC 111(a) claiming benefit under 35 USC 120 and 365(c) of PCT application JP2004/003145, filed Mar. 10, 2004.

### TECHNICAL FIELD

The present invention generally relates to a technology for optically writing information to an optical recording medium such as an optical disk (CD-ROM/CD-R/CD-RW&DVD-ROM/R/RW/RAM & DVD+RW/+R & WORM) and a magneto-optical disk (MO & MD), and, more particularly, to an apparatus for data transfer, a drive apparatus, an apparatus for optical information recording, a program for use in an apparatus for data transfer, a program for use in a drive apparatus, a storage medium for storing a program for use in an apparatus for data transfer, a storage medium for storing a program for use in a drive apparatus, a method of transferring data, and a method of driving.

### BACKGROUND ART

In the related art, equipment having a system configuration comprising an apparatus for data transfer (for example, a personal computer and a recorder) which transfers data for use in recording, and a drive apparatus (for example, an optical disk drive apparatus) which optically writes information in an optical recording medium (for example, an optical disk) according to data transferred from the apparatus for data transfer, is put into commercial use. As such equipment, there is an equipment set having a configuration in which one apparatus for data transfer and one drive apparatus are integrated into one unit, a representative of which is a DVD-recording apparatus. The DVD-recording apparatus comprises a DVD drive apparatus, and a DVD recorder which transfers the data for use in recording to the DVD drive apparatus.

In equipment having such a system configuration, the data for use in recording such as a video signal is converted to data processable at the drive apparatus. Furthermore, the apparatus for data transfer transfers the data to the drive apparatus. At the drive apparatus, the data received are cached at a cache memory so as to output the data cached at the cache memory at the timing in which the cache memory becomes close to full, or at the timing in which an instruction transmitted by the apparatus for data transfer is received, and to execute an operation of writing into such a medium as the optical disk, according to the data as described above. Herein, the instruction from the apparatus for data transfer is transmitted to the drive apparatus at the timing in which the data transfer is completed. Such an operation of data outputting at the drive apparatus according to the instruction from the apparatus for data transfer is called synchronized caching.

Conversely, Patent Document 1 describes a method of recording information in a manner such that, in a case where the optical disk includes a discontinuous area such as a zone boundary, data just preceding the discontinuous area are written in one recording operation so that data following are held in the cache memory and, in a case where there is an access instruction to a subsequent continuous area, data held in the cache memory and data subsequently received are collectively recorded.

Patent Document 1

JP10-106143A

In the drive apparatus, the process of writing information according to data held in its cache memory depends on the process at the drive apparatus. In other words, at what timing the data held in the cache memory are output is a matter to be determined solely at the drive apparatus, with no room for involvement by the apparatus for data transfer. Therefore, a process of transferring data at the apparatus for data transfer and a process of outputting data from the cache memory at the drive apparatus are not necessarily closely related.

Indeed, at the present, the apparatus for data transfer and the drive apparatus have a function called a buffer under-run prevention function. This function prevents a buffer under-run error, or an error which occurs at a time of writing data, as data transmission from the apparatus for data transfer to the drive apparatus may not be in time. Such buffer under-run prevention function enables a normal writing no matter at what timing data are transferred.

However, whether writing of data transferred to the drive apparatus has actually been started may not be known at the data transfer apparatus side. Therefore, in a case where there is a discontinuity among the spacings of data transferred from the apparatus for data transfer, data transferred to the drive apparatus are kept in the drive so the drive cannot be written into, drastically reducing efficiency. Furthermore, a case where a contingency such as a power failure occurs may result in a critical problem in which transferred data are destroyed.

### DISCLOSURE OF THE INVENTION

Accordingly, it is a general object of the present invention to provide a technology for optically writing information into an optical recording medium that substantially obviates one or more problems caused by the limitations and disadvantages of the related art.

It is a more particular object of the present invention to implement efficient use of a drive apparatus.

It is another more particular object of the present invention to prevent destruction of data by such reason as a contingency.

According to the invention, an apparatus for transferring data to a drive apparatus, the data being temporarily held in a memory of the drive apparatus for subsequent recording in a recording medium, includes: a first unit which performs for a plurality of repetitions a first process of transferring the data to the drive apparatus and a second process of converting data for a subsequent transfer to data processable at the drive apparatus, a second unit which indicates a timing in accordance with an amount of the data and a rate of transferring the data, and a third unit which causes the drive apparatus to record, during a period in which the second process is executed and the first process is not executed, in the recording medium at the indicated timing the data being temporarily held in the memory of the drive apparatus.

An apparatus for transferring data in an embodiment of the invention enables, even during the executing of a process of converting data at a drive apparatus in which the drive apparatus generally becomes dormant, executing an operation of writing information to the drive apparatus, and implementing efficient use of the drive apparatus. Moreover, operating the drive apparatus without its becoming dormant enables preventing, as much as possible, a state in which data continue to be held in its cache memory, and, thereby, even in a case in which a contingency such as a power failure occurs, preventing an occurrence of a critical problem such that data transferred are destroyed.

According to another aspect of the invention, a drive apparatus, which records in an optical recording medium data transferred from an apparatus for transferring data, the data being temporarily held in a cache memory for subsequent recording in the optical recording medium, includes: an optical pickup which irradiates the optical recording medium with a laser beam, a receiving unit which receives the data to be recorded by the drive apparatus transferred from the apparatus for transferring data, a caching unit which caches the data received at the cache memory, a signal-supplying unit which supplies a write-start signal so that the data are recorded during a period in which there is a discontinuity in the data transferred from the apparatus for transferring data, and a writing unit which controls the optical pickup in response to the write-start signal supplied so as to start optically writing the data cached at the cache memory into the optical recording medium.

A drive apparatus in an embodiment of the invention enables, even between receiving of data preceding and receiving of data following a period in which the drive apparatus generally becomes dormant, executing an operation of writing information at the drive apparatus, and implementing efficient use of the drive apparatus. Moreover, operating the drive apparatus without its becoming dormant enables preventing, as much as possible, a state in which data continue to be held in its cache memory, and, thereby, even in a case in which a contingency such as a power failure occurs, preventing an occurrence of a critical problem such that data transferred are destroyed.

According to another aspect of the invention, an apparatus for optical information recording includes an apparatus for transferring data, and a drive apparatus which records in an optical recording medium data transferred from the apparatus for transferring data, the data being temporarily held in a cache memory of the drive apparatus for subsequent recording in the optical recording medium, wherein the apparatus for transferring data includes a first unit which performs for a plurality of repetitions a first process of transferring the data to the drive apparatus and a second process of converting data, for a subsequent transfer, to data processable at the drive apparatus, a second unit which indicates a timing in accordance with an amount of the data and a rate of transferring the data, and a third unit which causes the drive apparatus to record, during a period in which the second process is executed and the first process is not executed, in the recording medium at the indicated timing, the data being temporarily held in the cache memory of the drive apparatus; wherein the drive apparatus includes an optical pickup which irradiates the optical recording medium with a laser beam, a receiving unit which receives the data to be recorded by the drive apparatus transferred from the apparatus for transferring data, a caching unit which caches the data received at the cache memory, a signal-supplying unit which supplies a write-start signal so that the data are recorded during a period in which there is a discontinuity in the data transferred from the apparatus for transferring data, and a writing unit which controls the optical pickup depending upon the write-start signal supplied so as to optically write the data cached at the cache memory into the optical recording medium.

An apparatus for optical information recording in an embodiment of the invention enables, even while executing a process of converting data at a drive apparatus in which the drive apparatus generally becomes dormant, or between receiving data preceding and receiving data following in which the drive apparatus generally becomes dormant, executing an operation of writing information at the drive apparatus, and implementing efficient use of the drive apparatus. Moreover, operating the drive apparatus without its becoming dormant enables preventing, as much as possible, a state in which data continues to be kept in its cache memory, and, thereby, even in a case in which a contingency such as a power failure occurs, reducing the likelihood of an occurrence of a critical problem such that data transferred are destroyed.

According to another aspect of the invention, a program for use in an apparatus for transferring data, which is machine readable, is installed in a computer included in the apparatus for transferring data to a drive apparatus, the data being temporarily held in a memory of the drive apparatus for subsequent recording in a recording medium, for causing the computer to perform for a plurality of repetitions a first process of transferring the data to the drive apparatus and a second process of converting data for a subsequent transfer to data processable at the drive apparatus, indicating a timing in accordance with an amount of the data and a rate of transferring the data, and causing the drive apparatus to record, during a period in which the second process is executed and the first process is not executed, in the recording medium at the indicated timing, the data being temporarily held in the memory of the drive apparatus.

A program for use in an apparatus for data transfer in an embodiment of the invention enables, even while executing a process of converting data at a drive apparatus in which the drive apparatus generally becomes dormant, executing an operation of writing information at the drive apparatus, and implementing efficient use of the drive apparatus. Moreover, operating the drive apparatus without its becoming dormant enables preventing, as much as possible, a state in which data continues to be held in its cache memory, and, thereby, even in a case in which a contingency such as a power failure occurs, preventing an occurrence of a critical problem such that data transferred are destroyed.

According to another aspect of the invention, a program for use in a drive apparatus, which is machine readable, is installed in a computer included in the drive apparatus, which records in an optical recording medium data transferred from an apparatus for transferring data, the data being temporarily held in a cache memory of the drive apparatus for subsequent recording in the optical recording medium, for causing the computer to perform: receiving the data to be recorded by the drive apparatus transferred from the apparatus for transferring data, caching the data received at the cache memory, supplying a write-start signal so that the data are recorded during a period in which there is a discontinuity in the data transferred from the apparatus for transferring data, and writing by controlling an optical pickup, irradiating the optical recording medium with a laser beam, in response to the write-start signal supplied so as to optically write the data cached at the cache memory into the optical recording medium.

A program for use in a drive apparatus in an embodiment of the invention enables, even between a receiving of data preceding and a receiving of data following a period in which the drive apparatus generally becomes dormant, executing an operation of writing information in the drive apparatus, and implementing an efficient use of the drive apparatus. Moreover, operating the drive apparatus without its becoming dormant enables preventing, as much as possible, a state in which data continue to be held in its cache memory, and, thereby, even in a case in which a contingency such as a power failure occurs, preventing an occurrence of a critical problem such that data transferred are destroyed.

According to another aspect of the invention, a method of transferring data, which is executed in an apparatus for transferring data to a drive apparatus, the data being temporarily held in a memory of the drive apparatus for subsequent recording in a recording medium, includes the steps of: performing for a plurality of repetitions a first process of transferring the data to the drive apparatus and a second process of converting data for a subsequent transfer to data processable at the drive apparatus, indicating a timing in accordance with the amount of data and the rate of transferring data, and causing the drive apparatus to record, during a period in which the second process is executed and the first process is not executed, in the recording medium at the indicated timing, the data being temporarily held in the memory of the drive apparatus.

A method of transferring data in an embodiment of the invention enables, even while executing a process of converting data at a drive apparatus in which the drive apparatus generally becomes dormant, executing an operation of writing information to the drive apparatus, and implementing an efficient use of the drive apparatus. Moreover, operating the drive apparatus without its becoming dormant enables preventing, as much as possible, a state in which data continue to be held in its cache memory, and, thereby, even in a case in which a contingency such as a power failure occurs, preventing an occurrence of a critical problem such that data transferred are destroyed.

According to another aspect of the invention, a method of driving, which is executed at a drive apparatus which records in an optical recording medium data transferred from an apparatus for transferring data, the data being temporarily held in a cache memory of the drive apparatus for subsequent recording in the optical recording medium, includes the steps of: receiving the data to be recorded by the drive apparatus transferred from the apparatus for transferring data, caching the data received at the cache memory, supplying a write-start signal so that the data are recorded during the period in which there is a discontinuity in the data transferred from the apparatus for transferring data, and writing by controlling an optical pickup, irradiating the optical recording medium with a laser beam, in response to the write-start signal supplied so as to optically write the data cached at the cache memory into the optical recording medium.

A method of driving in an embodiment of the invention enables, even between receiving data preceding and receiving data following in which the drive apparatus generally becomes dormant, executing an operation of writing information in the drive apparatus, and implementing efficient use of the drive apparatus. Moreover, operating the drive apparatus without its becoming dormant enables preventing, as much as possible, a state in which data continue to be held in its cache memory, and, thereby, even in a case in which a contingency such as a power failure occurs, preventing an occurrence of a critical problem such that data transferred are destroyed.

### BRIEF DESCRIPTION OF THE DRAWINGS

Other objects, features, and advantages of the present invention will become more apparent from the following detailed descriptions when read in conjunction with the accompanying drawings, in which:

FIG. 1 is a functional block diagram of a drive apparatus (an optical disk drive);

FIG. 2 is a block diagram which illustrates a hardware configuration of an apparatus for data transfer (a DVD recorder) FIG. 3 is a graph which illustrates, for data transfer with a high bit rate and a large data amount, a relationship between the elapsed time and the data amount;

FIG. 4 is a graph which illustrates, for data transfer with a low bit rate and a small data amount, a relationship between the elapsed time and the data amount;

FIG. 5 is a flowchart of an example of a process, from data receiving to data writing, which is executed at the drive apparatus (the optical disk drive);

FIG. 6 is a flowchart of another example of the process, from data receiving to data writing, which is executed at the drive apparatus (the optical disk drive);

FIG. 7 is a graph which illustrates, for data transfer with a variable bit rate and data amount, a relationship between the elapsed time and the data amount;

FIG. 8 is a flowchart of yet another example of the process, from data receiving to data writing, which is executed at the drive apparatus (an optical disk drive); and

FIG. 9 is a flowchart of an example of a process of transferring a data amount which is executed at the data transfer apparatus (a DVD recorder)

### BEST MODE FOR CARRYING OUT THE INVENTION

Descriptions are given next, with reference to the accompanying drawings, of embodiments of the present invention.

The present invention is not limited to the specifically disclosed embodiments, but variations and modifications may be made without departing from the scope of the present invention.

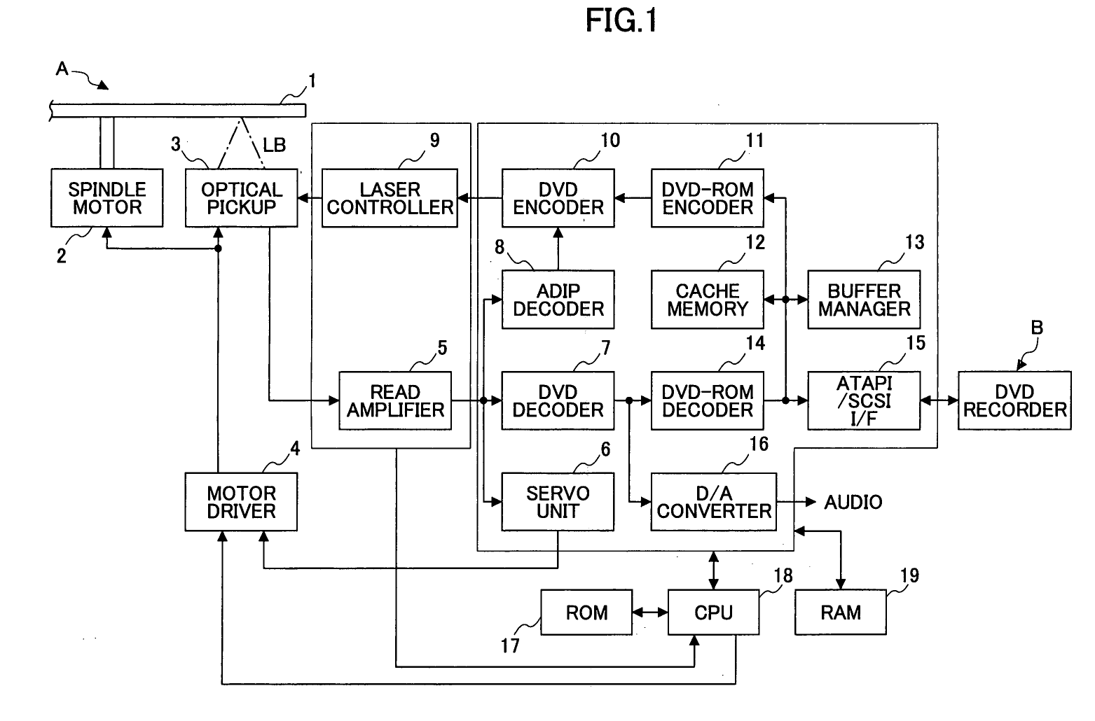

Embodiments according to the present invention are described, referring to FIG. 1 through FIG. 9.

The present embodiment is an example of an application to an apparatus enabled to write into and/or reproduce information in a DVD+RW, for example. Consequently, an apparatus according to the present embodiment comprises, as either one integrated piece or as separate pieces, an optical disk drive A as a drive apparatus and a DVD recorder B as an apparatus for data transfer. Below, basic configurations of the optical disk drive A and the DVD recorder B are described, followed by a detailed description of processes at the apparatuses.

(Optical Disk Drive A)

First, the optical disk drive A as an optical recording apparatus is described, referring to FIG. 1. FIG. 1 is a functional block diagram of the optical disk drive A.

The optical disk drive A executes an optical recording of information in an optical disk 1 as an optical recording medium. In FIG. 1, the numeral 1 represents the optical disk, 2 a spindle motor, 3 an optical pickup, 4 a motor driver, 5 a read amplifier, 6 a servo unit, 7 a DVD decoder, 8 an ADIP decoder, 9 a laser controller, 10 a DVD encoder, 11 a DVD-ROM encoder, 12 a buffer RAM (cache memory), 13 a buffer manager, 14 a DVD-ROM decoder, 15 an ATAPI/SCSI interface, 16 a D/A converter, 17 a ROM, 18 a CPU, 19 a RAM, and the letters LB a laser beam and Audio an audio output signal.

Moreover, in FIG. 1, arrows indicate the primary direction of data flow. Furthermore, for brevity, the CPU 18 which controls each of the blocks in FIG. 1 is illustrated with only a bold line, having omitted connections to each of the blocks.

The CPU 18, ROM 17, and RAM 19 as described above, which are illustrated with the connections to each of the blocks omitted, are a microcomputer which controls each of the blocks. The ROM 17 stores data that need to be kept over a long period such as a controlling program written in code decodable at the CPU 18, and a set of controlling parameters for various media. Furthermore, when the power of the optical disk drive A is turned on, the controlling program as described above is loaded in a memory (not shown) so that the CPU 18 controls operations of various units as described above according to the program, while data necessary for controlling are temporarily held in the RAM 19. As another embodiment, a controlling program may be stored in the RAM 19, using a battery backup or a nonvolatile-type RAM for the RAM 19.

In the optical disk drive A, the optical disk 1 is rotationally driven by the spindle motor 2. The spindle motor 2 is controlled at the motor driver 4 and the servo unit 6 so as to set linear or angular velocity as constant. The linear or angular velocity may be changed step-wise.

The optical pickup 3 comprising a semiconductor laser, an optical system, a focus actuator, a tracking actuator, receiving optics, and a position sensor (not shown) irradiates the optical disk 1 with the laser beam LB. Moreover, the optical pickup 3 is enabled by a seek motor (not shown) to move in the moving direction of a sled (not shown). Based on a signal obtained from the receiving optics and the position sensor, the focus actuator, the tracking actuator, and the seek motor are controlled at the motor driver 4 and the servo unit 6 so that a spot of the laser beam LB is positioned at a desired location on the optical disk 1.

Then, at the time of a read, a reproduced signal obtained at the optical pickup 3 is amplified and binarized at the read amplifier 5 so as to be input at the DVD decoder 7. The binarized input data are 8-16 demodulated at the DVD decoder 7. Furthermore, the recorded data are organized into groups of 8 bits so as to be modulated (8/16 modulated), the modulation converting 8 bits into 16 bits. In this case, bits for concatenation are appended so that the number of preceding “1”'s and the number of preceding “0”'s are made to be equal on the average. This is referred to as a “suppression of the DC component” in which a change in the slice level of the reproduced signal with the DC component cut is suppressed.

Processes of deinterleaving and error correcting are performed on demodulated data. Subsequently, the data are input at the DVD-ROM decoder 14 so that a further process of error correcting is performed so as to increase the reliability of the data. The data having been error-corrected twice are held temporarily at the cache memory 12 by the buffer manager 13 so as to be transferred, without stopping, via the ATAPI/SCSI interface 15 to the DVD recorder B as data comprising complete sectors. Furthermore, in a case of music data, data output from the DVD recorder 7 are input at the D/A converter 16 so as to be retrieved as the analog audio output signal Audio.

Moreover, at the time of a write, data transmitted from the DVD recorder B via the ATAPI/SCSI interface 15 are held temporarily at the cache memory 12 by the buffer manager 13. While an operation of the write is initiated subsequently, in such a case, the laser beam spot needs to be positioned at a point of starting the write. This point may be obtained by a wobble signal comprised in advance on the optical disk 1 by a zigzag movement of a track. The point of starting the write operation is obtained by a land prepit in lieu of the wobble signal in the case of a DVD−RW/−R and by a prepit in a case of a DVD-RAM/RAM & WO.

The wobble signal in the DVD+RW/+R disk comprises an address information called ADIP (ADdress In Pre-groove) which is taken out at the ADIP decoder 8. Moreover, a synchronization signal generated at the ADIP decoder 8 is input at the DVD encoder 10, enabling a data-write at an accurate position on the optical disk 1. To the data in the cache memory 12, such operations as appending of an error correction code and interleaving are performed at the DVD-ROM encoder 11 and the DVD encoder 10, and then the laser controller 9 activates and controls the optical pickup 3 so that recording of information in the optical disk 1 is performed.

As another embodiment, it may have a configuration in which address information is obtained from a land prepit or a prepit. Furthermore, the ATAPI/SCSI interface 15 illustrated as an example of an external interface, or even USB or an IEEE 1394, may be adopted.

(DVD Recorder B)

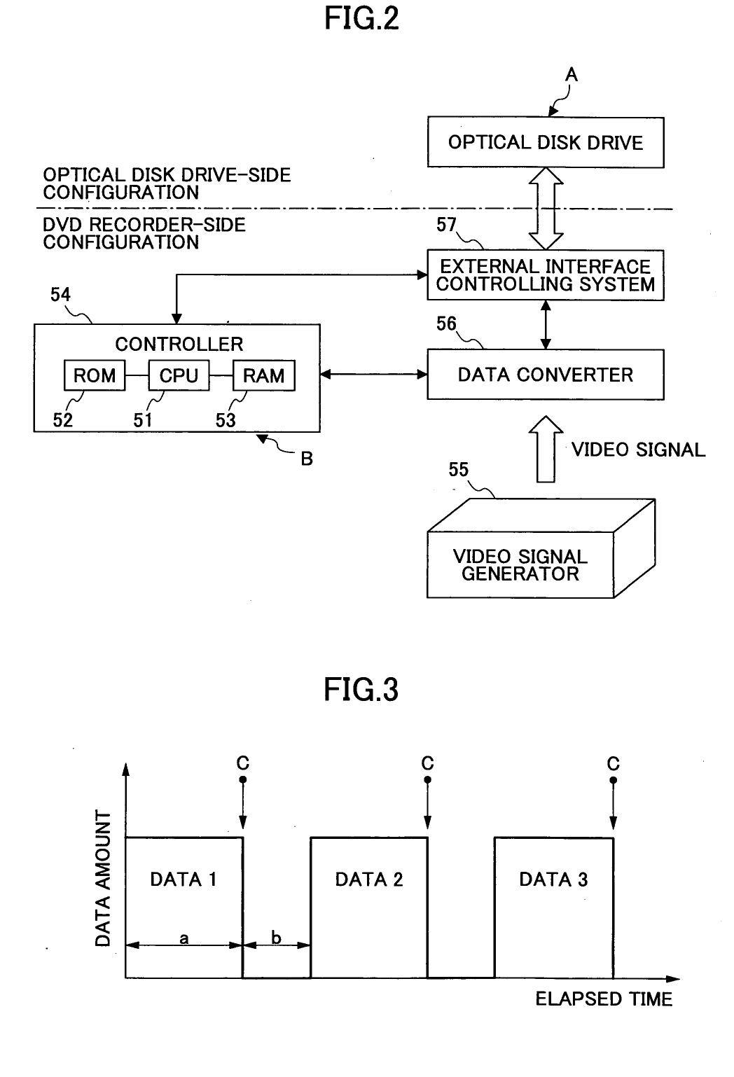

Next, the DVD recorder B as a data transfer apparatus is described, referring to FIG. 2. FIG. 2 is a block diagram which illustrates a hardware configuration of the DVD recorder B. The DVD recorder B comprises a controller 54 with a microcomputer configuration comprising a CPU 51, a ROM 52, and a RAM 53. In the ROM 52, data which need to be stored for a long period such as a controlling program written in a code readable at the CPU 51 are stored. When the power of the DVD recorder B is turned on, the controlling program is loaded to a memory (not shown), the CPU 51 controlling operations of each of the units as well as temporarily holding in the RAM 53 data needed for the controlling. As another embodiment, the controlling program may be stored in the RAM 53 by using a battery backup or non-volatile RAM for the RAM 53.

The DVD recorder B, putting the controller 54 as the nerve center, comprises, for example, a video signal generator 55 which generates a video signal such as MPEG, a data converter 56 which converts the video signal to data processable at the optical disk drive A, and an external interface controlling system 57. Each of the units as described above is controlled at the controller 54. Moreover, as for the video signal generator 55, the data converter 56, and the external interface controlling system 57, the descriptions are omitted as there are no differences from identical units comprised in a generally-used DVD recorder. As for the external interface controlling system 57, ATAPI, SCSI, USB, or IEEE 1394 may be adopted.

Herein, the data converter 56 executes a process of converting data in which recording data are converted in predetermined units to data processable at the optical disk drive A. Moreover, the external interface controlling system 57 executes a process of transferring data in which converted data are transferred to the optical disk drive A. The controller 54 causes the data converter 56 and the external interface controlling system 57 to repeat multiple times such processes of converting and transferring data. Hereby, the functions of the data transfer and conversion units (steps, functions) are executed.

Thus, the DVD recorder B, with a function of converting a video signal into data writeable into the optical disk drive A, enables controlling the amount of data to be converted.

(Details of Processes at the Optical Disk Drive A and the DVD Recorder B)

According to the present embodiment, data are transferred from a DVD recorder B to an optical disk drive A. In this case, the speed of the data transfer is generally referred to as a bit rate. The higher the bit rate the faster the data transfer, or the lower the bit rate the slower the data transfer.

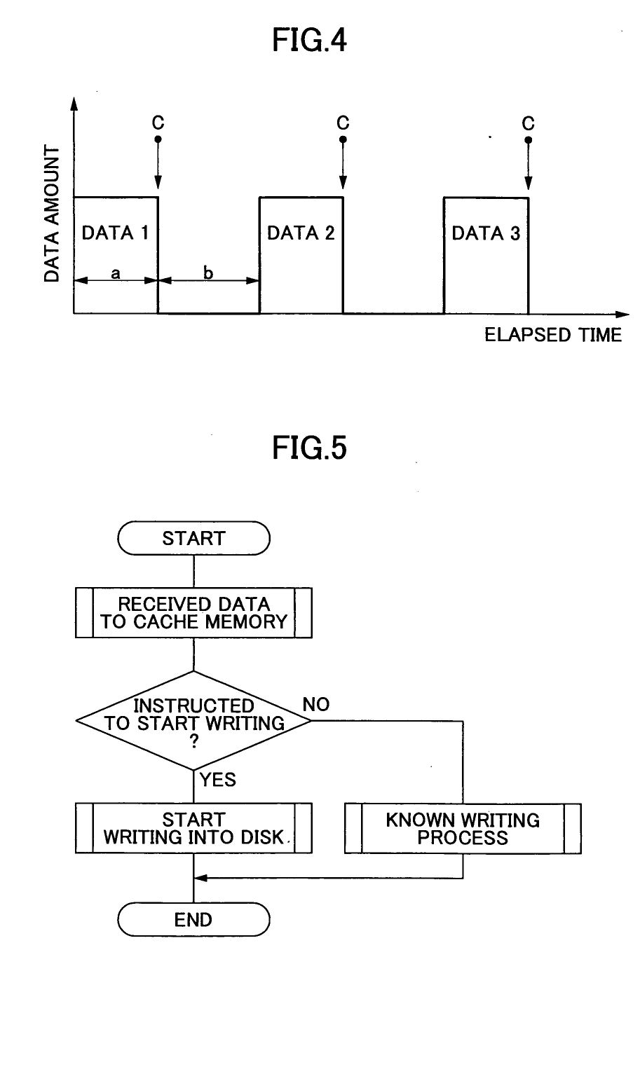

FIG. 3 is a graph for a data transfer with a high bit rate and a large data amount, showing a relationship between the elapsed time and the data amount, while FIG. 4 is a graph for a data transfer with a low bit rate and a small data amount, showing a relationship between the elapsed time and the data amount. In the graphs of FIG. 3 and FIG. 4, “a” represents the time required to transfer, to the optical disk drive A via the external interface controlling system 57, a video signal generated at the video signal generator 55 so as to be converted at the data converter 56, and “b” represents the time required to convert, at the data converter 56, the video signal generated at the video signal generator 55. Herein, as described above, in a known optical disk drive, received data are cached at a cache memory so that the data cached at the cache memory are output at the timing in which the cache memory is close to full so as to make the optical disk execute the write operation, according to the data as described above. Therefore, the optical disk drive A, referring to the graphs in FIG. 3 and FIG. 4, receives data transferred in a segment “a”. On the other hand, the optical disk drive A is dormant in a segment “b”. Therefore, as described above, in a case where there is a discontinuity among the spacings of data transferred from the DVD recorder B as the data transfer apparatus, some data transferred to the optical disk drive A as the drive apparatus is held in the optical disk drive A as the drive apparatus so as not to be written yet, drastically reducing efficiency. Furthermore, in a case where a contingency such as a power failure occurs within the segment “b” as described above, it may lead to a critical problem in which the data transferred are destroyed.

In the present embodiment, with an intention of solving such a problem, in the graphs of FIG. 3 and FIG. 4, at the timing “c”, a write-start signal is generated at the optical disk drive A. Hereby, during the time in which no controlling is performed on the optical disk drive A, or during the time the optical disk drive A is on standby, writing of data held in the cache memory in the optical disk drive A is started. Hereby, efficient use of the optical disk drive A is enabled so as to reduce, even in a case where a contingency such as a power failure occurs, the likelihood of such a critical problem resulting in the data transferred being destroyed.

Therefore, according to the present embodiment, in the DVD recorder B, the timing “c” of generating the write-start signal at the optical disk drive A is set so as to execute the operation of writing information at the optical disk drive during an executing of the data conversion process at the data converter 56 based on the amount and the transfer speed of data transferred to the optical disk drive A (a unit for setting the timing, a function of setting the timing, and a step of setting the timing) so as to generate the write-start signal at the optical disk drive A at the timing “c” set as described above. In other words, herein, regardless of the bit rate of the data transfer (referring to FIG. 3 and FIG. 4), a process of generating the write-start signal at the optical disk drive A at the timing “c” is enabled, such that the operation of writing information at the optical disk drive A during the executing of the data conversion process at the data conversion unit 56 is executed. Herein, the DVD recorder B recognizes in advance the bit rate of the data transfer as well as the amount of data that it is transferring on its own. Therefore, at the DVD recorder B, referring to the amount and the bit rate of the data transferred to the optical disk drive A enables an easy setting of the timing “c” in which the write-start signal is generated at the optical disk drive so that the operation of writing information at the optical disk drive A during the executing of the data conversion process at the data converter 56 is performed. Thus, according to the present embodiment, at the DVD recorder B, at the timing “c”, the write-start signal is transferred from the DVD recorder B to the optical disk drive A so that the operation of writing information at the optical disk drive A is performed during the executing of the data conversion process at the data converter 56.

Furthermore, when the external interface of the optical disk drive A is the ATAPI/SCSI interface 15, in a case that the external interface controlling system 57 also uses an ATAPI method, the write-start signal is enabled with the use of the ATAPI packet command (a combination of Write command and option) for an easy transfer to the optical disk drive A.

FIG. 5 is a flowchart which illustrates a process, from data receiving to data writing, which is executed at the CPU 18 according to the controlling program loaded in a memory.

The CPU 18 in the optical disk drive A, upon receiving recording data from the DVD recorder B (a unit for receiving, a function of receiving , and a step of receiving), caches received data in the cache memory 12 (a unit for caching, a function of caching, and a step of caching). Herein, the time required to receive recording data from the DVD recorder B so as to cache the data received at the cache memory 12, in the graphs illustrated in FIG. 3 and FIG. 4, is the time “a” required to transfer to the optical disk drive A via the external interface controlling system 57 a video signal generated at the video signal generator 55 so as to be converted at the data converter 56.

Then, the CPU 18 in the optical disk drive A, upon receiving recording data from the DVD recorder B, stands by for determining whether there is received a write-start signal. In a case of not receiving the write-start signal, the CPU 18 in the optical disk drive A actuates and controls such a unit as the optical pickup 3 so as to execute a known writing process. The known writing process, as described above, is a process in which at the timing the cache memory 12 becomes close to full, or at the timing an instruction transmitted from the DVD recorder B is received in a case that transferring of all the data is completed, data cached at the cache memory 12 are output so as to execute an operation of writing into the optical disk 1 according to such data.

On the other hand, the CPU 18 in the optical disk drive A, in a case of determining receiving the write-start signal (a unit for generating a signal, a function of generating a signal, an a step of generating a signal), actuates and drives such a unit as the optical pickup 3 so as to execute operations of writing into the optical disk 1 according to the data cached at the cache memory 12 (a unit for writing, a function of writing, and a step of writing). The timing of executing such an operation of writing into the optical disk 1 is the timing “c” as illustrated in FIG. 3 and FIG. 4. The timing, as described above, may be positioned as during the executing of the data conversion process at the data converter 56 for the DVD recorder B and as between receiving the data preceding and receiving the data following, for the DVD recorder A. Therefore, the operation of writing information at the optical disk drive A is executed so as to efficiently use the optical disk drive A even during the executing of the data conversion process at the DVD recorder B in which the optical disk drive A is dormant or between receiving the data preceding and receiving the data following. Moreover, as the optical disk drive A operates without becoming dormant, a state in which the data continues to be held in the cache memory 12 is prevented as much as possible, thereby reducing as much as possible the likelihood of a critical problem in which transferred data are destroyed even in a case that a contingency such as a power failure occurs.

In the process according to the present embodiment as described above, the write-start signal is transferred to the optical disk drive A at the timing “c” set at the DVD recorder B side. The transfer of the write-start signal in this case is executed successively each time a predetermined unit of data is transferred to the optical disk drive A. In this case, a setting of the timing “c” to an ideal timing is enabled as the CPU 51 at the DVD recorder B recognizes the amount and the bit rate of data transferring on its own.

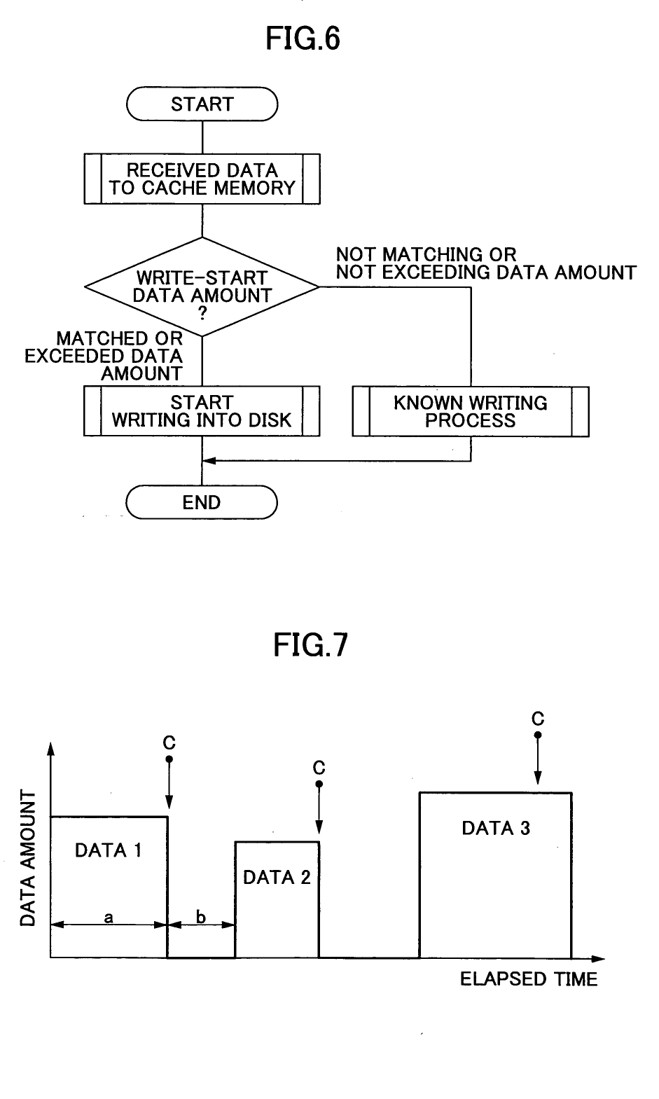

On the other hand, the data transfer illustrated in FIG. 3 and FIG. 4 uses a CBR (Constant Bit Rate). The timing “c” in which the write-start signal is generated is enabled to be set to some extent to be constant. Such controlling is described in another embodiment according to a flowchart in FIG. 6. FIG. 6 is a flowchart which illustrates for the optical disk drive A a process, from data receiving to data writing, which is executed at the CPU 18 according to a controlling program loaded in a memory.

The CPU 18 in the optical disk drive A, upon receiving recording data from the DVD recorder B (a unit for receiving, a function of receiving, and a step of receiving), caches the received data at the cache memory 12 (a unit for caching, a function of caching, and a step of caching). Herein, the time required to receive recording data from the DVD recorder B so as to cache the received data at the cache memory 12, in the graphs illustrated in FIG. 3 and FIG. 4, is a time “a” required to transfer via the external interface controlling system 57 to the optical disk drive A a video signal generated at the video signal generator 55 so as to be converted at the data converter 56.

Then, the CPU 18 in the optical disk drive A, upon receiving recording data from the DVD recorder B, determines whether the amount of the data is greater than or equal to a predetermined amount. The predetermined amount in this case may be reported in advance to the optical disk drive A by the DVD recorder B, or set by the optical disk drive A on its own. In either case, such predetermined amount determines the timing of generating a write-start signal. Such timing of generating the write-start signal may be positioned for the DVD recorder B as during the executing of the data conversion process at the data converter 56 and for the optical disk drive A as between receiving the data preceding and receiving the data following. This means that, in a case of the DVD recorder B reporting in advance to the optical disk drive A the predetermined amount, such predetermined amount would be Xdata for generating, at the timing set, the write-start signal by the optical disk drive A. Furthermore, as for the reporting of the predetermined amount from the DVD recorder B to the optical disk drive A, when the external interface of the optical disk drive A is the ATAPI/SCSI interface 15, in a case that the external interface controlling system 57 in the DVD recorder B uses an ATAPI method, use of ATAPI packet commands (a vendor-unique page of mode sense/select commands) enables an easy transfer to the optical disk drive A.

The CPU 18 in the optical disk drive A, in a case that the amount of the data received from the DVD recorder B is greater than or equal to the predetermined amount, actuates and controls such units as the optical pickup 3 so as to execute a known writing process. The known writing process, as described above, is a process such that, at the timing in which the cache memory 12 becomes close to full, or at the timing in which an instruction transmitted from the DVD recorder B is received in a case that transferring of all the data is completed, the data cached at the cache memory 12 are output so as to execute a process of writing into the optical disk 1 according to such data.

On the other hand, the CPU 18 in the optical disk drive A generates a write-start signal in a case that the amount of the data received from the DVD recorder B is greater than or equal to the predetermined amount (a unit for generating a signal, a function of generating a signal, and a step of generating a signal) Then, according to the generated write-start signal, such a unit as the optical pickup 3 is actuated and controlled so that the operation of writing into the optical disk 1 according to the data cached at the cache memory 12 is executed (a unit for writing, a function of writing, and a step of writing). The timing of executing of such operation of writing into the optical disk 1 is the timing “c” in the FIG. 3 and FIG. 4 which the optical disk drive A generates on its own. Such timing, as described above, may be positioned for the DVD recorder B as during the data conversion process by the data converter 56 and for the optical disk drive A as between receiving the data preceding and receiving the data following. Therefore, the operation of writing information at the optical disk drive A is executed even during the data conversion process at the DVD recorder B in which the optical disk drive A is generally dormant, or between receiving the data preceding and receiving the data following at the optical disk drive A, enabling an efficient use of the optical disk drive A. Moreover, the optical disk drive A continues to operate without becoming dormant, preventing as much as possible data from being continued to be kept in the cache memory 12, thereby reducing as much as possible, even in a case that a contingency such as a power failure occurs, the likelihood of a critical problem such that transferred data is destroyed.

FIG. 7 is a graph which illustrates, for a data transfer with a variable bit rate and data amount, a relationship between the elapsed time and the data amount. The graphs in FIG. 3 and FIG. 4 illustrate the case in which the data transfer from the DVD recorder B to the optical disk drive A is performed at a CBR (Constant Bit Rate). On the other hand, in the case that the data transfer from the DVD recorder B to the optical disk drive A is performed at a VBR (Variable Bit Rate), a time “a” which is the time required to transfer via the external interface controlling system 57 to the optical disk drive A a video signal generated at the video signal generator 55 and converted at the data converter 56, and a time “b” which is the time required to convert at the data converter 56 the video signal generated at the video signal generator 55 are not constant. Such a point as described above may be obvious, referring to data 1, 2, and 3 in FIG. 7. Thus, in a case where the data transfer from the DVD recorder B to the optical disk drive A is performed at a CBR (Constant Bit Rate), setting as constant the timing “c” of generating the write-start signal makes a setting of the timing “c” to an ideal timing impossible.

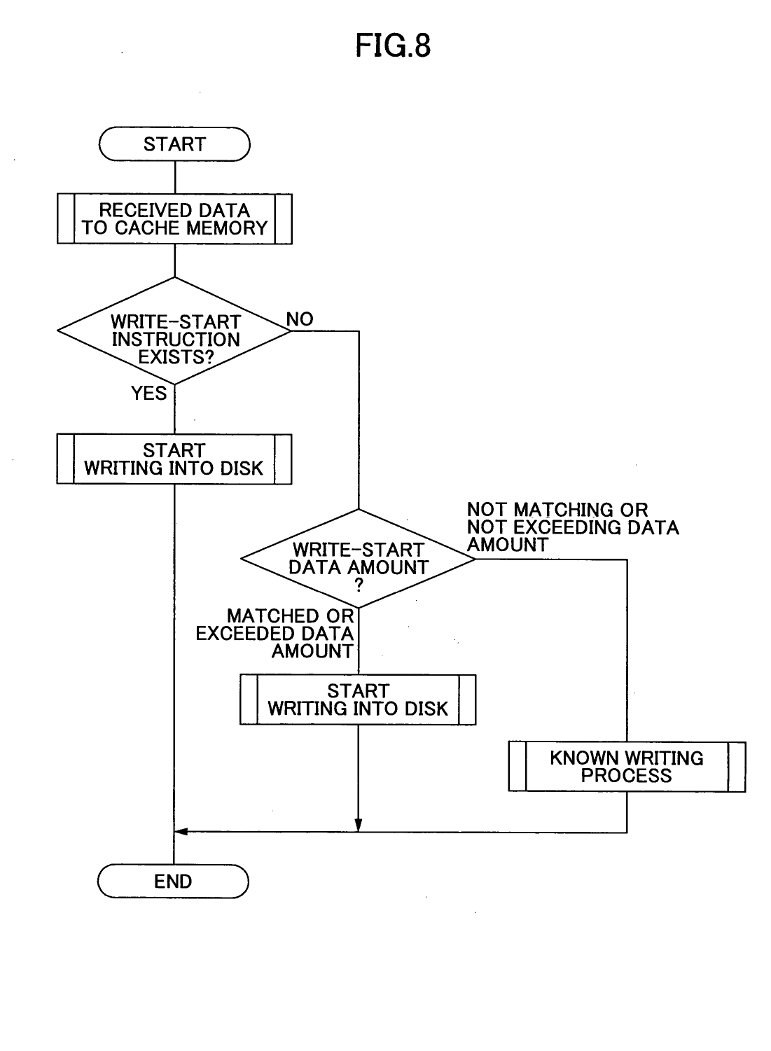

Thus, as yet another embodiment, there is a need to perform controlling different from the second embodiment as described above. Such controlling is described as another embodiment according to the flowchart as illustrated in FIG. 8. FIG. 8 is a flowchart which illustrates a process from data receiving to data writing which is executed at the CPU 18 according to the controlling program loaded in the memory.

The CPU 18 in the optical disk drive A, upon receiving recording data from the DVD recorder B (a unit for receiving, a function of receiving, and a step of receiving), caches the received data at the cache memory 12. Herein, the time required to receive recording data from the DVD recorder B and to cache the received data at the cache memory 12, in the graphs illustrated in FIG. 3 and FIG. 4, is the time “a” required to transfer to the optical disk drive A via the external interface controlling system 57 a video signal generated at the video signal generator 55 and converted at the data converter 56.

Next, the CPU 18 in the optical disk drive A, upon receiving recording data from the DVD recorder B, stands by for a determination of whether a write-start signal exists.

In a case that the write-start signal does not exist, a determination as to whether the amount of the recording data received from the DVD recorder B is greater than or equals a predetermined amount is made. The predetermined amount in this case may be reported in advance to the optical disk drive A by the DVD recorder B, or may be set by the optical disk A on its own. In either case, the predetermined amount determines the timing of generating a write-start signal. The timing of generating such a write-start signal may be positioned for the DVD recorder B as during the executing of the data conversion process at the data converter 56 and for the optical disk drive A as between the receiving of data preceding and the receiving of data following. This means that, in a case of the DVD recorder B reporting in advance the predetermined amount to the optical disk drive A, such predetermined amount would be data for generating by the optical disk drive A the write-start signal at the timing set. Furthermore, as for the reporting of the predetermined amount from the DVD recorder B to the optical disk drive A, as the external interface of the optical disk drive A is the ATAPI/SCSI interface 15, in a case that the external interface controlling system 57 also uses the ATAPI method, use of ATAPI packet command (a combination of write command and option) enables an easy transfer to the optical disk drive A.

The CPU 18 in the optical disk drive A, in a case of not determining that the amount of data received from the DVD recorder B is not greater than or equal to the predetermined amount, actuates and controls such unit as the optical pickup 3 and executes a known writing process. The known writing process, as described above, is a process in which, at the timing the cache memory 12 becomes close to full, or at the timing the instruction transmitted from the DVD recorder B in a case that the transferring of all the data is completed, the data cached at the cache memory 12 are output so as to execute the write operation according to such data.

On the other hand, the CPU 18 in the optical disk drive A, in a case of determining that the amount of data received from the DVD recorder B is greater than or equal to the predetermined amount, generates a write-start signal (a unit for generating a signal, a function of generating a signal, and a step of generating a signal) Then, according to the generated write-start signal, a unit such as the optical pickup 3 is actuated and controlled so as to execute an operation of writing into the optical disk 1 according to the data cached at the cache memory 12 (a unit for writing, a function of writing, and a step of writing). Such timing of executing operation of writing into the optical disk 1 is the timing “c” as illustrated in FIG. 3 and FIG. 4, generated by the optical disk drive A on its own. Such timing, as described above, may be positioned for the DVD recorder B as during executing of the data conversion process at the data converter 56 and for the optical disk drive A as between receiving the data preceding and receiving the data following. Therefore, even during executing of the data conversion process at the DVD recorder B in which the optical disk drive A generally becomes dormant, or between receiving the data preceding and receiving the data following at the optical disk drive A, the operation of writing information into the optical disk drive A is performed, enabling an efficient use of the optical disk drive A. Moreover, the optical disk drive A operates without becoming dormant, preventing as much as possible from the data being continued to be held at the cache memory 12, thereby reducing as much as possible the likelihood of a critical problem such as transferred data being destroyed.

On the other hand, with the data 2 in FIG. 7, in a case that the bit rate is low and the data amount is small, with controlling based on the specified amount as described above, efficient use of the optical disk drive A is not possible. In such a case, the time of making the optical disk drive A dormant becomes less in a case of generating a write-start signal earlier than generating the write-start signal at the timing in which the data cached at the cache memory 12 is greater than or equal to the predetermined amount.

Thus, in such a case, the write-start signal is generated at the DVD recorder B so as to transmit such write-start signal to the optical disk drive A. Hereby, the CPU 18 at the optical disk drive 18 determines receiving of the write-start signal (a unit for generating a signal, a function of generating a signal, and a step of generating a signal), actuates and controls such a unit as the optical pickup 3 according to the received write-start signal so as to execute the operation of writing into the optical disk 1 according to the data cached at the cache memory 12 (a unit for writing, a function of writing, and a step of writing) Hereby, a shortening as much as possible of the time that the optical disk drive A is dormant is enabled. Therefore, even during executing of the data conversion process at the DVD recorder B in which the optical disk drive A generally becomes dormant, or between receiving the data preceding and receiving the data subsequent at the optical disk drive A, the operation of writing information into the optical disk drive A is executed, enabling an efficient use of the optical disk drive A. Moreover, as the optical disk drive A operates without becoming dormant, preventing as much as possible the data from being continued to be kept at such a cache memory 12, thereby reducing as much as possible the likelihood of a critical problem such that the transferred data are destroyed, is enabled.

Furthermore, in the first and the third embodiments as described above, in the DVD recorder B, the process of setting the timing “c” in which the write-start signal is generated in the optical disk drive A is executed. At the time of setting such timing “c”, the DVD recorder B, recognizing in advance the bit rate of the data transfer as well as the amount of the data to be transferred on its own, refers to the amount and the bit rate of the data to be transferred to the optical disk drive A. In this case, in the DVD recorder B, knowing the amount of data cached at the cache memory 12 in the optical disk drive A enables a setting of the timing “c”, in which the write-start signal is generated in the optical disk drive A, as an ideal timing “c”. As the amount of data cached at the cache memory 12 specifies the time required for the operation of writing at the optical disk drive A, as a example, a case is envisioned in which it may be better to generate a write-start signal in the optical disk drive A at an earlier timing depending upon the amount of the data cached.

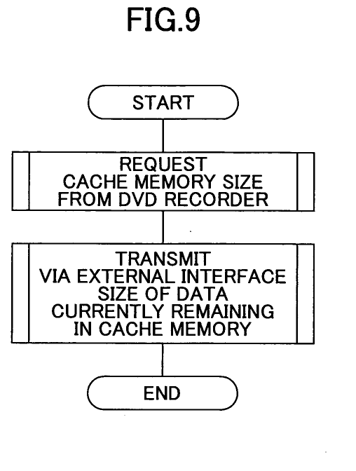

Thus, in the present embodiment, a process of reporting data size as an amount of data cached at the cache memory 12 is executed from the optical disk drive A to the DVD recorder B. FIG. 9 is a flowchart which illustrates an example of a process of transferring the amount of data which is executed at the DVD recorder B.

First, a request for transferring the size of data cached at the cache memory 12 is transmitted from the DVD recorder B to the optical disk drive A. Then, at the optical disk drive A, based on such request, the amount of the data cached at the cache memory is obtained so as to transmit such data to the DVD recorder B (a unit for receiving a report at the DVD recorder B, and a unit for reporting at the optical disk drive A). As for communications between such DVD recorder B and the optical disk drive A, as the external interface of the optical disk drive A is the ATAPI/SCSI interface 15, in a case of making the external interface controlling system 57 in the DVD recorder B as an ATAPI method, ATAPI packet commands (a vendor unique page of mode sense/select commands) enable easy executing.

Therefore, the DVD recorder B which becomes aware of the amount of data cached at the cache memory 12 in the optical disk drive enables a setting of the timing “c”, in which the write-start signal is generated at the disk drive A, as the more ideal timing “c”.

The present application is based on the Japanese Priority Application No. 2003-077976 filed on Mar. 20, 2003, the entire contents of which are hereby incorporated by reference.

1. An apparatus for transferring data to a drive apparatus, said data being temporarily held in a memory of the drive apparatus for a subsequent recording in a recording medium, comprising:
a first unit which performs, for a plurality of repetitions, a first process of transferring said data to the drive apparatus and a second process of converting data for a subsequent transfer to data processable at the drive apparatus;
a second unit which indicates a timing in accordance with an amount of the data and a rate of the transferring of the data; and
a third unit which causes the drive apparatus to record, during a period in which the second process is executed and the first process is not executed, in the recording medium at the indicated timing said data being temporarily held in the memory of the drive apparatus.

2. The apparatus for transferring data as claimed in claim 1, wherein said third unit transfers, at the timing indicated by said second unit, to said drive apparatus a write-start signal which causes said drive apparatus to start recording in the recording medium.

3. The apparatus for transferring data as claimed in claim 1, wherein said third unit transfers to said drive apparatus information regarding data to be stored in the memory for causing, at the timing indicated by said second unit, said drive apparatus to start recording in the recording medium.

4. The apparatus for transferring data as claimed in claim 1, further comprising a fourth unit which receives from said drive apparatus information regarding the amount of said data stored in the memory,
wherein said second unit refers to the amount of said data stored in the memory to determine the timing.

5. A drive apparatus which records in an optical recording medium data transferred from an apparatus for transferring data, said data being temporarily held in a cache memory for a subsequent recording in the optical recording medium, comprising:
an optical pickup which irradiates said optical recording medium with a laser beam;
a receiving unit which receives the data to be recorded by said drive apparatus transferred from said apparatus for transferring data;
a caching unit which caches the data received at the cache memory;
a signal-supplying unit which supplies a write-start signal so that the data are recorded during a period in which there is a discontinuity in the data transferred from said apparatus for transferring data; and
a writing unit which controls said optical pickup in response to the write-start signal supplied so as to start optically writing the data cached at said cache memory into said optical recording medium.

6. The drive apparatus as claimed in claim 5, wherein said signal-supplying unit receives the write-start signal from said apparatus for transferring data.

7. The drive apparatus as claimed in claim 5, wherein said signal-supplying unit supplies the write-start signal in a case that an amount of the data cached at said cache memory is greater than or equal to a predetermined amount.

8. The drive apparatus as claimed in claim 5, further comprising a reporting unit which reports information regarding an amount of the data cached at said cache memory to said apparatus for transferring data.

9. An apparatus for optical information recording, comprising:
an apparatus for transferring data; and
a drive apparatus which records in an optical recording medium data transferred from said apparatus for transferring data, said data being temporarily held in a cache memory of the drive apparatus for a subsequent recording in the optical recording medium,
wherein said apparatus for transferring data comprises:
a first unit which performs for a plurality of repetitions a first process of transferring said data to the drive apparatus and a second process of converting data for a subsequent transfer to data processable at the drive apparatus;
a second unit which indicates a timing in accordance with an amount of the data and a rate of the transferring of the data; and
a third unit which causes the drive apparatus to record, during a period in which the second process is executed and the first process is not executed, in the recording medium at the indicated timing said data being temporarily held in the cache memory of the drive apparatus; and
wherein said drive apparatus comprises:
an optical pickup which irradiates said optical recording medium with a laser beam;
a receiving unit which receives the data to be recorded by said drive apparatus transferred from said apparatus for transferring data;
a caching unit which caches the data received at the cache memory;
a signal-supplying unit which supplies a write-start signal so that the data are recorded during a period in which there is a discontinuity in the data transferred from said apparatus for transferring data; and
a writing unit which controls said optical pickup depending upon the write-start signal supplied so as to optically write the data cached at said cache memory into said optical recording medium.

10. The apparatus for optical information recording as claimed in claim 9, comprising said apparatus for transferring data and said drive apparatus as one integrated piece.

11. The apparatus for optical information recording as claimed in claim 9, comprising said apparatus for transferring data and said drive apparatus as separate pieces.

12. A program for use in an apparatus for transferring data, which is machine readable, installed at a computer comprised in the apparatus for transferring data to a drive apparatus, said data being temporarily held in a memory of the drive apparatus for a subsequent recording in a recording medium, for causing the computer to perform:
for a plurality of repetitions, a first process of transferring said data to the drive apparatus and a second process of converting data for a subsequent transfer to data processable at the drive apparatus;
indicating a timing in accordance with an amount of the data and a rate of the transferring of the data; and
causing the drive apparatus to record, during a period in which the second process is executed and the first process is not executed, in the recording medium at the indicated timing said data being temporarily held in the memory of the drive apparatus.

13. A program for use in a drive apparatus, which is machine readable, installed at a computer comprised in the drive apparatus which records in an optical recording medium data transferred from an apparatus for transferring data, said data being temporarily held in a cache memory of the drive apparatus for a subsequent recording in the optical recording medium, for causing the computer to perform:
receiving the data to be recorded by said drive apparatus transferred from said apparatus for transferring data;
caching the data received at the cache memory;
supplying a write-start signal so that the data are recorded during a period in which there is a discontinuity in the data transferred from said apparatus for transferring data; and
writing by controlling an optical pickup, irradiating said optical recording medium with a laser beam, in response to the write-start signal supplied so as to optically write the data cached at said cache memory into said optical recording medium.

14. A storage medium which stores the program for use in the apparatus for transferring data as claimed in claim 12.

15. A storage medium which stores the program for use in the drive apparatus as claimed in claim 13.

16. A method of transferring data which is executed at an apparatus for transferring data to a drive apparatus, said data being temporarily held in a memory of the drive apparatus for a subsequent recording in a recording medium, comprising the steps of:
performing, for a plurality of repetitions, a first process of transferring said data to the drive apparatus and a second process of converting data for a subsequent transfer to data processable at the drive apparatus;
indicating a timing in accordance with an amount of the data and a rate of the transferring of the data; and
causing the drive apparatus to record, during a period in which the second process is executed and the first process is not executed, in the recording medium at the indicated timing said data being temporarily held in the memory of the drive apparatus.

17. A method of driving which is executed at a drive apparatus which records in an optical recording medium data transferred from an apparatus for transferring data, said data being temporarily held in a cache memory of the drive apparatus for a subsequent recording in the optical recording medium, comprising the steps of:
receiving the data to be recorded by said drive apparatus transferred from said apparatus for transferring data;
caching the data received at the cache memory;
supplying a write-start signal so that the data are recorded during a period in which there is a discontinuity in the data transferred from said apparatus for transferring data; and
writing by controlling an optical pickup, irradiating said optical recording medium with a laser beam, in response to the write-start signal supplied so as to optically write the data cached at said cache memory into said optical recording medium.
